(19) United States
(12) Patent Application Publication
(10) Pub. No.: US 2009/0182816 A1
(43) Pub. Date: Jul. 16, 2009

(54) METHOD AND SYSTEM FOR MANAGING J2EE AND .NET INTEROPERATING APPLICATIONS

(76) Inventor: Jean Xu Yu, Austin, TX (US)

Correspondence Address: IBM CORP (YA);C/O YEE & ASSOCIATES PC, P.O. BOX 802333, DALLAS, TX, 75380, US

(21) Appl. No.: 11/972,030

(22) Filed: Jan. 10, 2008

(51) Int. Cl. G06F 15/16

(52) U.S. Cl. 709/206

(57) ABSTRACT

A computer implemented method, system, and computer usable program code for managing a transaction between a service client and a service provider is provided. A request from a Web services client application is received. A correlation token and a unique transaction handle associated with the correlation token are extracted from the request, forming an extracted correlation token and an extracted transaction handle. A child correlation token is generated using the extracted correlation token as a parent correlation token. A unique transaction handle associated with the child correlation token is generated. A timer associated with the unique transaction handle and child correlation token is started. The request is performed. The timer associated with the unique transaction handle is stopped. The extracted transaction handle is inserted in a response to the request. The response with the extracted transaction handle is transmitted to a Web services client application.

### BACKGROUND OF THE INVENTION

1. Field of the Invention

The present invention relates generally to the data processing field and, more particularly, to a computer implemented method, system and computer usable program code for managing .NET and J2EE transactions in a coexistence environment such as in a Service Oriented Architecture (SOA) environment.

2. Description of the Related Art

A Service Oriented Architecture (SOA) is a collection of loosely coupled services available in the World Wide Web. Following years of development, essentially all major system vendors now have an SOA strategy for providing integration solutions/professional services, product portfolios and partner offerings. The nature of an SOA (i.e., heterogeneous, distributed, dynamic and open) means that an implementation of an SOA would be integrated business processes, including invocations of Web services, running on heterogeneous vendor platforms.

It is a fact that .NET and J2EE platforms coexist in most SOA implementations. As a result, efficient and robust interoperability between .NET and J2EE is a crucial element in the IT architecture of large enterprises. J2EE and .Net vendors each provide management solutions for their own platforms.

However, while significant advancements have been made in the area of SOA implementations, room for improvement exists. Currently, no method exists to track transactions that cross server/platform boundaries. Applicants recognized that tracking transactions that cross server/platform boundaries would provide for increased interoperability and efficiency.

There is, accordingly, a need for a mechanism for managing .NET and J2EE transactions in a coexistence environment, such as a Service Oriented Architecture environment.

### SUMMARY OF THE INVENTION

Exemplary embodiments provide a computer implemented method, system, and computer usable program code for managing a transaction between a service client and a service provider. A request from a Web services client application is received. A correlation token and a unique transaction handle associated with the correlation token are extracted from the request, forming an extracted correlation token and an extracted transaction handle. A child correlation token is generated using the extracted correlation token as a parent correlation token. A unique transaction handle associated with the child correlation token is generated. A timer associated with the unique transaction handle and child correlation token is started. The request is performed. The timer associated with the unique transaction handle is stopped. The extracted transaction handle is inserted in a response to the request. The response with the extracted transaction handle is transmitted to a Web services client application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which exemplary embodiments may be implemented;

FIG. 2 is a block diagram of a data processing system in which exemplary embodiments may be implemented;

FIG. 3 is a block diagram that schematically illustrates a basic Service Oriented Architecture (SOA) to assist in explaining exemplary embodiments;

FIG. 4 is a block diagram that schematically illustrates tracking of a transaction that flows from a .NET platform to a J2EE platform according to an exemplary embodiment;

FIG. 5 is a block diagram that schematically illustrates tracking of a transaction that flows from a J2EE platform to a .NET platform according to an exemplary embodiment;

FIG. 6 is a diagram that schematically illustrates accessing raw XML SOAP messages using a .NET SOAP extension module according to an exemplary embodiment;

FIG. 7 is a topology view that illustrates a transaction flow from a .NET platform to a J2EE platform according to an exemplary embodiment;

FIG. 8 is a topology view that illustrates a transaction flow from a .NET platform to a J2EE platform (Drill down) according to an exemplary embodiment;

FIG. 9 is a topology view that illustrates a transaction flow from a J2EE platform to a .NET platform according to an exemplary embodiment;

FIG. 10 is a topology view that illustrates a transaction flow from a J2EE platform to a .NET platform (Drill down) according to an exemplary embodiment;

FIG. 11 is a flowchart that illustrates a method for tracking a transaction that flows from a .NET platform to a J2EE platform according to an exemplary embodiment; and

FIG. 12 is a flowchart that illustrates tracking of a transaction that flows from a J2EE platform to a .NET platform according to an exemplary embodiment.

### DETAILED DESCRIPTION OF THE PREFERRED EMBODIMENT

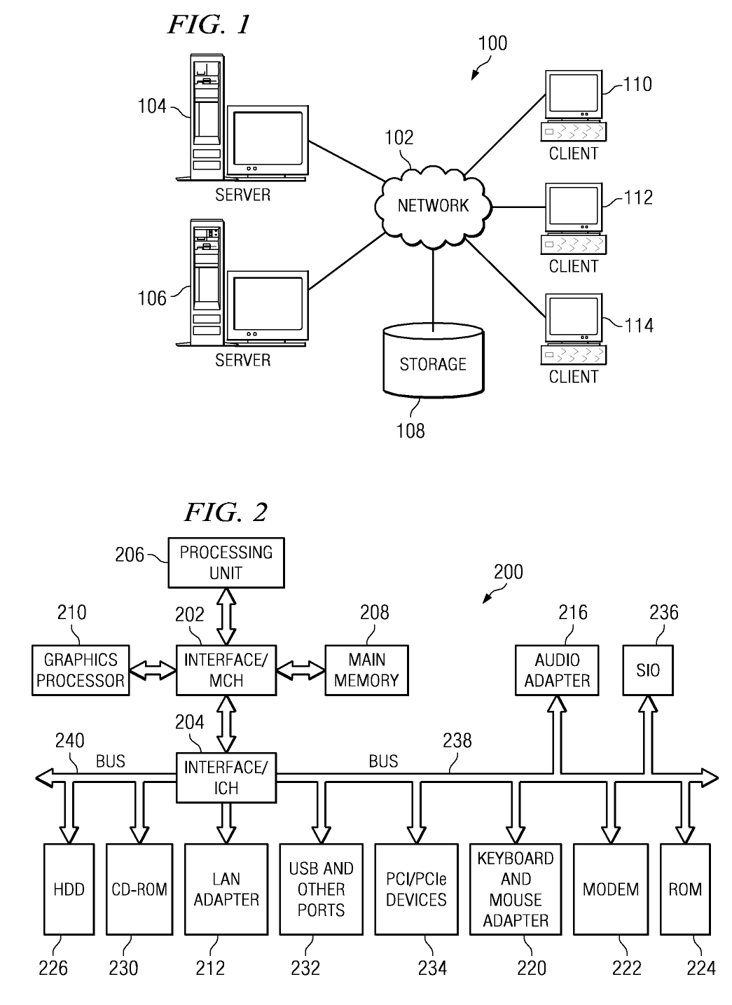

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, servers 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different exemplary embodiments.

With reference now to FIG. 2, a block diagram of a data processing system is shown in which exemplary embodiments may be implemented. Data processing system 200 is an example of a computer, such as server 104 or client 110 in FIG. 1, in which computer usable program code or instructions implementing the processes may be located for the exemplary embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). HDD 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the JAVA™ programming system, may run in conjunction with the operating system and provides calls to the operating system from JAVA™ programs or applications executing on data processing system 200. JAVA™ and all JAVA™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the exemplary embodiments may be performed by processing unit 206 using computer implemented instructions, which may be located in a memory such as, for example, main memory 208, read only memory 224, or in one or more peripheral devices.

The hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1 and 2 and above-described examples are not meant to imply architectural limitations. For example, data processing system 200 also may be a tablet computer, laptop computer, or telephone device in addition to taking the form of a PDA.

Exemplary embodiments provide a computer implemented method, system and computer usable program code for managing .NET and J2EE transactions in a coexistence environment, such as in a Service Oriented Architecture (SOA) environment.

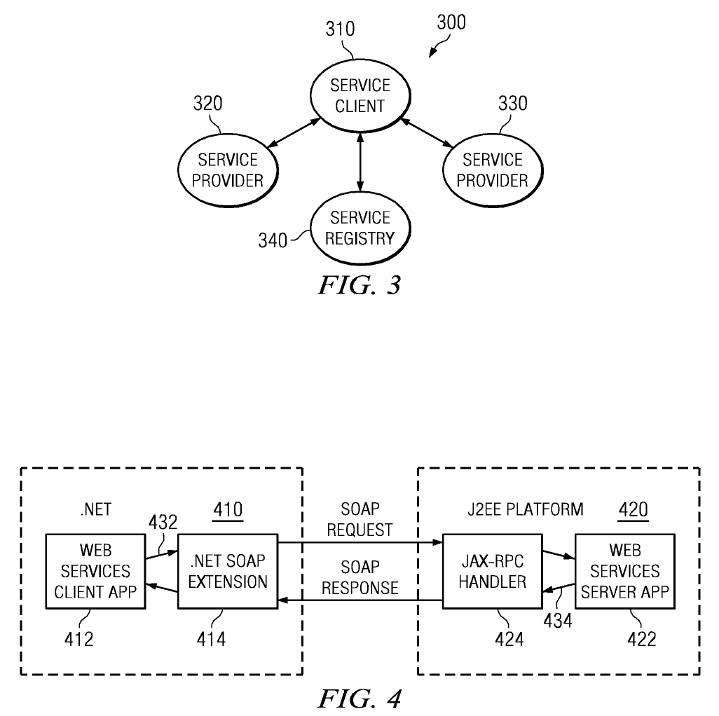

FIG. 3 is a block diagram that schematically illustrates a basic Service Oriented Architecture (SOA) to assist in explaining exemplary embodiments. The SOA is generally designated by reference number 300 and includes service client 310 and service providers 320 and 330. Service client 310 can be implemented, for example, as one of clients 110, 112 and 114 in FIG. 1; and service providers 320 and 330 can be implemented as servers 104 and 106 in FIG. 1. In the exemplary embodiment illustrated in FIG. 3, service client 310 sends a service request to one of service providers 320 and 330, and the service provider receiving the request returns a response message to service client 310.

As shown in FIG. 3, SOA 300 may also include service registry 340 that provides a directory or registry of services. A service client, such as service client 310, can discover services that are being offered by examining service registry 340.

Message exchanges in an SOA are usually performed via the Simple Object Access Protocol (SOAP), which is based on XML (eXtensible Markup Language). Exemplary embodiments manage a coexisting .NET/J2EE environment based on the SOAP/XML standard, although it should be understood that exemplary embodiments are not limited to using the SOAP/XML standard.

In accordance with an exemplary embodiment, a SOAP header is defined to enable correlation tokens to be exchanged between .NET and J2EE platforms. These correlation tokens are passed across .NET application domains using an ILogicalThreadAffirmative interface and CallContext object. A module is provided to pass correlation tokens in and out of the .NET platform by manipulating the SOAP headers in the message traffic. This module is dynamically loaded by the .NET platform as a global SOAP extension. The module can also be used to provide management functionality such as response time management, context-based routing, Service Level Agreement (SLA) management, and the like.

In accordance with a further exemplary embodiment, a similar module can be designed for the J2EE platform using a JAX-RPC or JAX-WS handler mechanism. JAX-RPC is a JAVA™ API (Application Programming Interfaces) for XML-based RPC (Remote Procedure Call) that enables JAVA™ technology developers to build Web applications and Web services incorporating XML-based RPC functionality according to the SOAP. JAX-WS stands for JAVA™ API for XML-based Web Services. JAX-WS is the replacement for JAX-RPC. JAX-RPC version 2.0 was renamed to JAX-WS version 2.0.

FIG. 4 is a block diagram that schematically illustrates tracking of a transaction that flows from a .NET platform to a J2EE platform according to an exemplary embodiment. More particularly, FIG. 4 illustrates a scenario in which a .NET Web service client invokes a J2EE Web service from a J2EE service provider according to an exemplary embodiment. The .NET web service client maybe implemented, for example, as service client 310 in FIG. 3, and the J2EE service provider maybe, for example, implemented as one of service providers 320 and 330 in FIG. 3.

The service client's .NET platform is generally designated by reference number 410, and the service provider's J2EE platform (server) is generally designated by reference number 420. The .NET platform 410 includes Web services client application 412 and .NET SOAP extension module 414. The service provider's J2EE platform 420 includes Web services server application 422 and JAX-RPC handler 424. JAX-RPC handler 424 may be implemented as a JAX-RPC handler or as a JAX-WS handler.

In operation, when Web services client application 412 invokes SOAP request 432 for a J2EE Web service from a J2EE service provider, .NET SOAP extension module 414 intercepts the SOAP request 432 from Web services client application 412 and attaches a correlation token in the SOAP header before the message reaches J2EE platform 420. At J2EE platform 420, the correlation token is extracted by JAX-RPC handler 424 before the request reaches Web services server application 422. The SOAP response 434 from Web services server application 422 is intercepted by JAX-RPC handler 424 before it is returned to .NET platform 410.

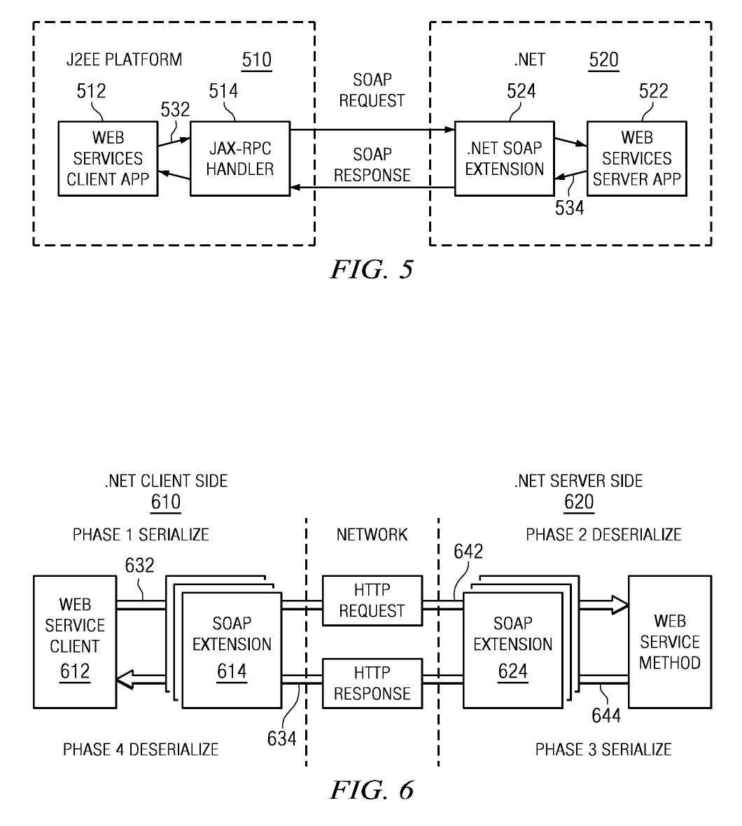

FIG. 5 is a block diagram that schematically illustrates tracking of a transaction that flows from a J2EE platform to a .NET platform according to an exemplary embodiment. In FIG. 5, JAX-RPC handler 514 in J2EE platform 510 intercepts SOAP request 532 from Web services client application 512, and attaches a correlation token in the SOAP header before the message reaches .NET server platform 520. At .NET server platform 520, the correlation token is extracted by .NET SOAP extension module 524 before the request reaches Web services server application 522. The SOAP response 534 is intercepted by JAX-RPC handler 514 before it is returned to the J2EE platform 510. JAX-RPC handler 514 may be implemented as a JAX-RPC handler or as a JAX-WS handler.

Using .NET SOAP extension modules 414 or 524 in FIGS. 4 and 5, respectively, allows access to new XML SOAP messages into and out of the .NET framework. FIG. 6 is a diagram that schematically illustrates accessing raw XML SOAP messages using a .NET SOAP extension module according to an exemplary embodiment. In general, tracking transactions across boundaries using a correlation token involves four (4) phases. Phases 1 and 4 occur on the client side of the transaction and phases 2 and 3 occur on the server side of the transaction.

In general, on .NET client side 610, an outgoing SOAP request 632 from Web services client application 612 is processed by .NET SOAP extension module 614 after it is serialized (phase 1). An incoming SOAP response 634 is processed by .NET SOAP extension module 614 before it is deserialized (phase 4). On .NET server side 620, an incoming SOAP request 642 is processed by the .NET SOAP extension module 624 before the message is deserialized (phase 2), and an outgoing SOAP response 644 is processed after the message is serialized (phase 3).

Referring still to FIG. 6, accessing raw XML SOAP messages with a .NET extension is more specifically described as follows:

On .NET client side 610 in the .NET framework, .NET SOAP extension module 614 (phase 1):
a) Extracts a parent correlation token (CO) from the Call Context Object and creates a child correlation token (C1);
b) Starts a transaction timer for the current transaction (a unique transaction handle H1 is created and associated with C1) in the outgoing request SOAP header; and
c) Adds the transaction correlation token (C1) and transaction handle (H1) in the outgoing request SOAP header.

When a response comes back to the client and before the response is deserialized, the .NET SOAP extension module 614 does the following (phase 4):
d) Extracts the transaction handle (H1) from the SOAP message header; and
e) Stops the transaction timer with handle (H1).

On .NET server side 620 in the .NET framework before the SOAP request is deserialized, the .NET SOAP extension module 624 does the following (phase 2):
a) Extracts the last correlation token from the client side (C1);
b) Creates a new correlation token (C2) using correlation token C1 as the parent;
c) Starts the timer for the current transaction (C2 with transaction handle H2);
d) Adds the current correlation token (C2) and handle (H2) to the Call Context;
e) Repeats steps b, c and d for all downstream server side transactions when they are completed; and
f) Stops the timers for downstream server side transactions when they are completed;

After the SOAP response is serialized, .NET SOAP extension module 624 does the following (phase 3):
g) Stops the timer for C2 (with handle H2); and
h) Leaves the transaction handle (H1) in the outgoing SOAP response header and passes the transaction handle (H1) back to the client.

To instrument the JAX-RPC or JAX-WS Web Services using the JAX-RPC or JAX-WS handler, all JAX-RPC or JAX-WS handlers implement the JAVAx.xml.rpc.handler.Handler interface. There are three methods for handling SOAP requests, responses and faults, respectively:

boolean handleRequest (MessageContext context)

boolean handleResponse (MessageContext context)

boolean handleFault (MessageContext context).

For each JAX-RPC or JAX-WS handler registered with the client or the server for a single Web service invocation, handleRequest is always invoked. However, either handleResponse or handleFault method is called based on the outcome of the invocation. The steps for the J2EE Web service are parallel to those used in the .NET, with a few minor differences, which are as follows:

On the J2EE Web service client side, during phase 1, the handleRequest method, rather than the SOAP extension, starts the timer for client Web service request (correlation token C1 and unique transaction handle H1). Also, the handleRequest method, rather than the SOAP extension, passes the correlation token (C1) and transaction handle (H1) via the SOAP request header.

When a response comes back to the client and before the response is deserialized (phase 4), the handleResponse or handleFault method, rather than the SOAP extension, extracts the transaction handle, and stop the timer for client Web services request.

On the J2EE Web service server side, during phase 2, the handleRequest method starts the timer for server side Web service transaction(s). Also, the handleRequest method, passes the correlation token in the JAVA Thread Local Storage.

On the J2EE Web service server side, during phase 3, before the response is sent back to the client, the handleResponse or handleFault method stops the timers for the server side Web service transaction. Additionally, the handleResponse or handleFault method places the transaction handle (H1) of the client in the SOAP response header and pass it back to the client.

It is desirable that a well-known, recognizable format be defined for correlation tokens and the manner by which the correlation tokens are represented in SOAP messages. An exemplary SOAP header is the following, in which the text between the <interop:correlatorxmins:interop=“http://tivoli.ibm.com”> and the </interop:correlator> represents the correlation token

<soapenv: Header>

<interop:correlatorxmins:interop=“http://tivoli.ibm.com”>

0072CCA0030050000000000000000011111111111111110000000000000
00000009B00005A4DBE593A327E1BCF05728834392F780D400000000448
9C2400000FE5000000000000009B00000000DBE593A327E1BCF05728834
392F780D4000000004489CE2400000FE5000000000000009B0000000000
0009B000041510000

</interop:correlator>

<soapenv:Header >

The CallContext is designed to hold a set of named objects that flow with the execution code path within a single application domain. By exposing the ILogical Thread Affinitive interface with the correlation token object, the correlation token can be passed outside the application domain (even into a remote .NET host). The following is a sample code, in C#:

namespace TransactionHandlerLib
{

[Serializable]
public class Correlation Token :
ILogicalThreadAffinitive
{

private Stack<TransactionData>correlatorStack;
.....

}

}

The JAVA Thread Local Storage, JMX Message Context, and HTTP header can be used to pass correlation tokens in J2EE Application Servers. WebSphere Request Metrics has an implementation of J2EE transaction correlation. Websphere is an example of a J2EE platform. Exemplary embodiments are directed to the correlation between .NET and J2EE and the correlation within the .NET platform.

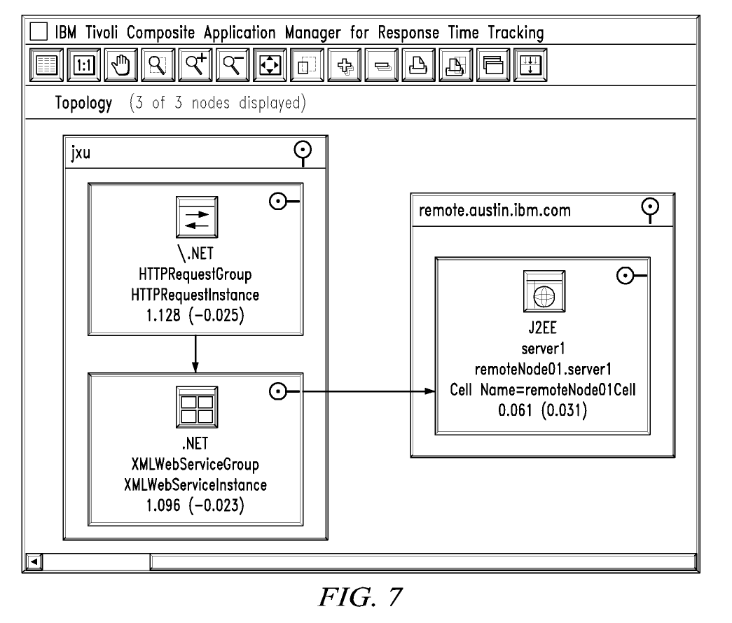

FIGS. 7 through 10 are sample topology views illustrating transaction flows according to exemplary embodiments. The topology views were generated according to exemplary embodiments, and the interoperating test environments comprised a .NET Web services client invoking a J2EE Web service, and a J2EE Web service client invoking a .NET Web service.

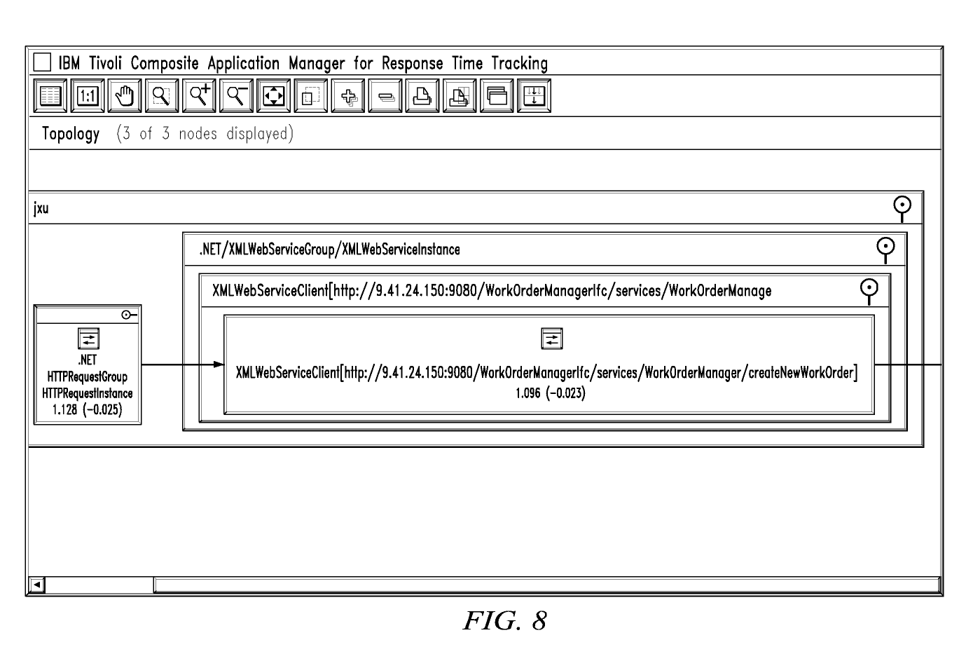

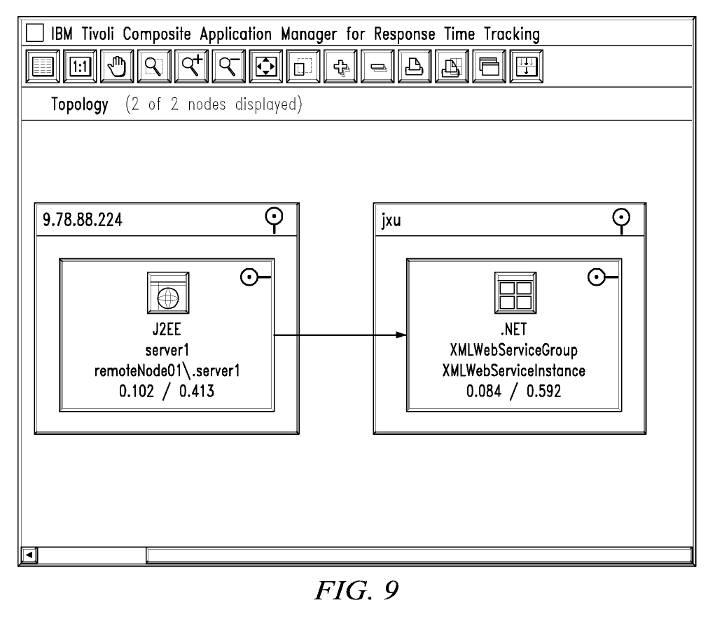

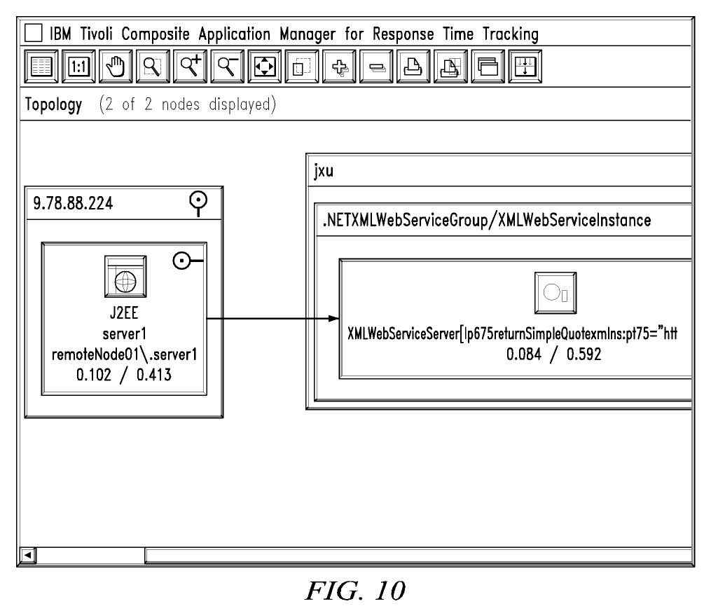

FIG. 7 is a topology view that illustrates a transaction flow from a .NET platform to a J2EE platform according to an exemplary embodiment. FIG. 8 is a topology view that illustrates a transaction flow from a .NET platform to a J2EE platform (Drill down) according to an exemplary embodiment. FIG. 9 is a topology view that illustrates a transaction flow from a J2EE platform to a .NET platform according to an exemplary embodiment. FIG. 10 is a topology view that illustrates a transaction flow from a J2EE platform to a .NET platform (Drill down) according to an exemplary embodiment.

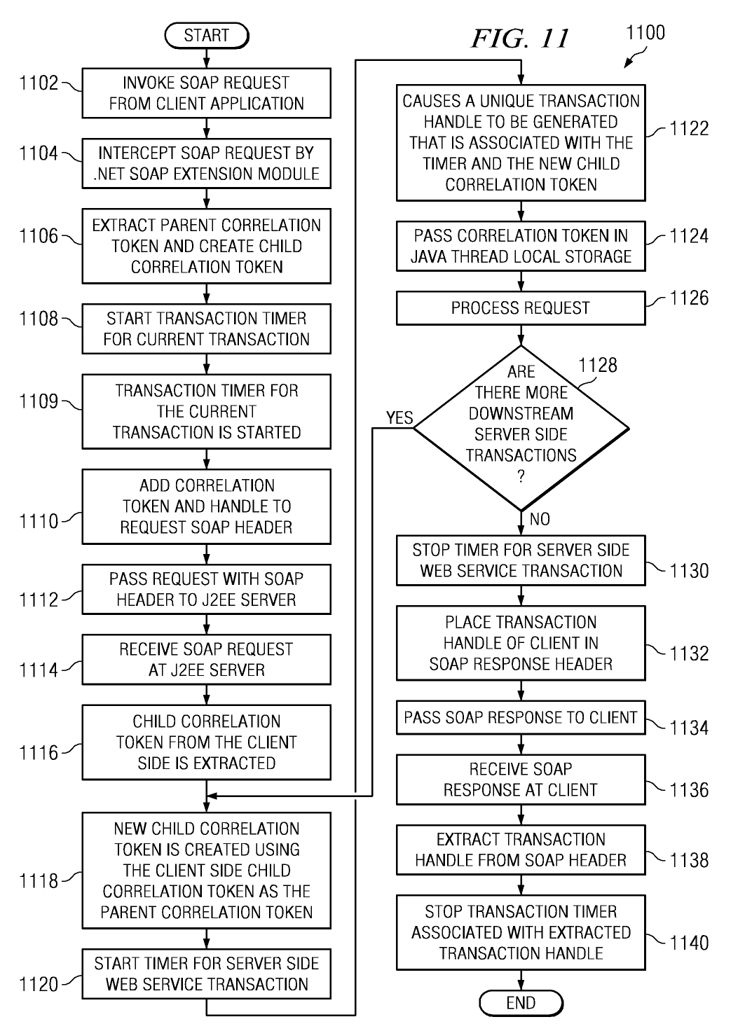

FIG. 11 is a flowchart that illustrates a method for tracking a transaction that flows from a .NET platform to a J2EE platform according to an exemplary embodiment. The method is generally designated by reference number 1100, and begins by a SOAP request being invoked from a Web services client application (step 1102). The SOAP request is intercepted by a .NET SOAP extension module on the .NET platform after it has been serialized (step 1104). The .NET SOAP extension module extracts a parent correlation token and creates a child correlation token in the SOAP header (step 1106).

A transaction timer for the current transaction is started (step 1108), which causes a unique transaction handle to be generated that is associated with the transaction timer and the child correlation token (step 1109). The child correlation token and the transaction handle for the current transaction are added to the SOAP header (step 1110). The message with the SOAP header is then passed to a J2EE server (step 1112). The SOAP request is received at the J2EE server (step 1114).

The child correlation token from the client side is extracted (step 1116). A new child correlation token is created using the client side child correlation token as the parent correlation token (step 1118). A timer for the server side J2EE platform transaction is started (step 1120), which causes a unique transaction handle to be generated that is associated with the timer and the new child correlation token (step 1122). The new child correlation token and transaction handle are passed in the JAVA thread local storage (step 1124). The request is processed (step 1126). A determination is made as to whether there are more downstream server side transactions (step 1128).

If there are more downstream server side transactions (a “yes” output to step 1128), the operation returns to step 1118. If there are no more downstream server side transactions (a “no” output to step 1128), then, before the response is returned to the .NET client, the timer for the server side Web service transaction is stopped (step 1130). The transaction handle of the client is placed in the SOAP response header (step 1132), and the SOAP response is passed to the client (step 1134).

The SOAP response is received by the client (step 1136), the transaction handle is extracted from the SOAP message header (step 1138) and the transaction timer associated with the extracted transaction handle is stopped (step 1140), and the method ends. As a transaction handle is uniquely identified with a correlation token and a specific transaction timer, the transaction handle is all that is necessary to identify the proper transaction and transaction timer in order to stop the timer.

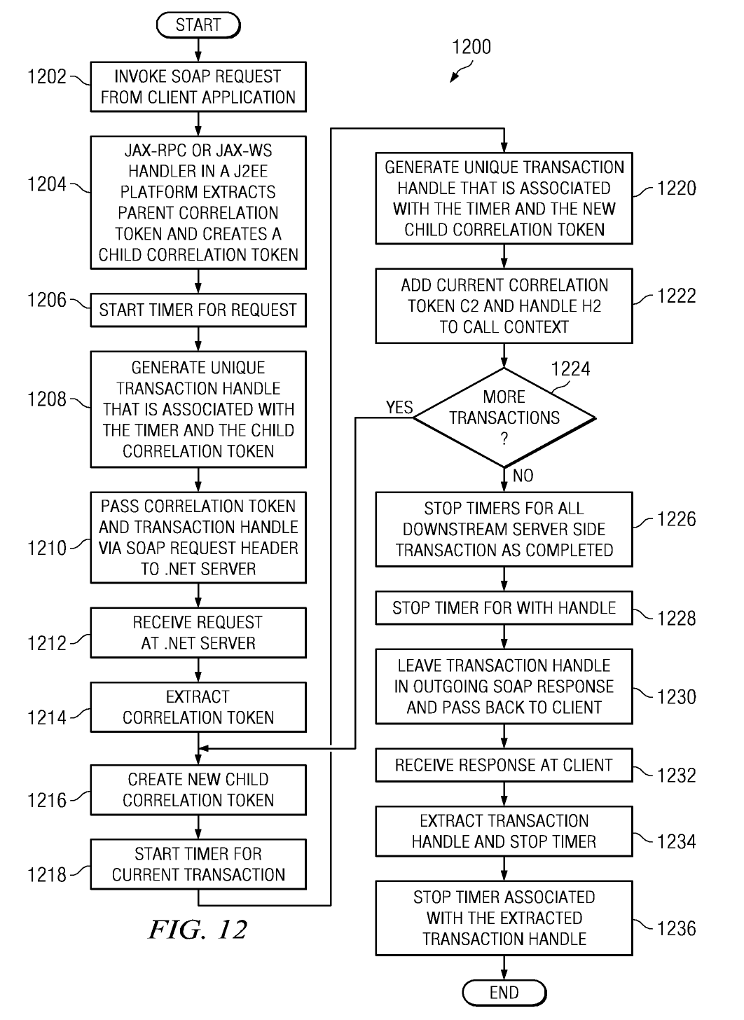

FIG. 12 is a flowchart that illustrates tracking of a transaction that flows from a J2EE platform to a .NET platform according to an exemplary embodiment. The method is generally designated by reference number 1200, and begins by a SOAP request being invoked from a Web services client application (step 1202). JAX-RPC or JAX-WS handler in a J2EE platform extracts parent correlation token and creates a child correlation token (step 1204), starts a timer for the request (step 1206), which causes a unique transaction handle to be generated that is associated with the timer and the child correlation token (step 1208) and passes the child correlation token and transaction handle via the SOAP request header to a .NET server (step 1210).

The .NET server receives the request (step 1212), and the SOAP extension module extracts the child correlation token from the client side from the SOAP request header (step 1214). A new child correlation token is created using the client side child correlation token C1 as the parent correlation token (step 1216). A timer for the current transaction is started (step 1218), which causes a unique transaction handle to be generated that is associated with the timer and the new child correlation token (step 1220). The new child correlation token and transaction handle are added to the Call Context (step 1222).

A determination is made as to whether there are more downstream server side transactions (step 1224). If it is determined that there are more downstream server side transactions (a “yes” output of step 1224), the method returns to step 1216. If it is determined that there are no more downstream server transactions (a “no” output of step 1224), the timers for all downstream server side transaction s are stopped as they are completed (step 1226). The timer is then stopped for the transaction with new child correlation token and associated unique transaction handle (step 1228). The transaction handle associated with client side child correlation token is left in the outgoing SOAP response header and that transaction handle is passed to the client (step 1230).

The response is received at the client (step 1232) and the transaction handle is extracted from the SOAP message header (step 1234), and the timer associated with the extracted transaction handle is stopped (step 1236), and the method ends. As a transaction handle is uniquely identified with a correlation token and a specific transaction timer, the transaction handle is all that is necessary to identify the proper transaction and transaction timer in order to stop the timer.

Exemplary embodiments thus provide a computer implemented method, system, and computer usable program code for managing a transaction between a service client and a service provider. In accordance with an exemplary embodiment, a SOAP header is defined to enable correlation tokens to be exchanged between .NET and J2EE platforms. These correlation tokens are passed across .NET application domains using an ILogicalThreadAffirmative interface and CallContext object. A module is provided to pass correlation tokens in and out of the .NET platform by manipulating the SOAP headers in the message traffic. This module is dynamically loaded by the .NET platform as a global SOAP extension. The module can also be used to provide management functionality such as response time management, context-based routing, Service Level Agreement (SLA) management, and the like.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The invention can also take the form of a computer program product, which has been downloaded over a network from one device to another for use in the other device. For instance, the program code stored in a computer readable storage medium in a server data processing system may be downloaded over a network from the server to a remote data processing system, such as a client or another server. Likewise, the program code stored in a computer readable storage medium in a client data processing system may be downloaded over a network from the client to a remote data processing system, such as a server or another client.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a transaction between a service client and a service provider, the computer implemented method comprising:
receiving a request from a Web services client application;
extracting a correlation token and a unique transaction handle associated with the correlation token from the request, forming an extracted correlation token and an extracted transaction handle;
generating a child correlation token using the extracted correlation token as a parent correlation token;
generating a unique transaction handle associated with the child correlation token;
starting a timer associated with the unique transaction handle and child correlation token;
performing the request;
stopping the timer associated with the unique transaction handle;
inserting the extracted transaction handle in a response to the request; and
transmitting the response with the extracted transaction handle to the Web services client application.

2. The computer implemented method of claim 1, wherein the request is a SOAP request.

3. The computer implemented method of claim 2, further comprising:
defining a SOAP message header format that allows for correlation tokens to be exchanged between the service client and the service provider, wherein the service client and the service provider reside on different platforms.

4. The computer implemented method of claim 3, wherein the different platforms are a .NET platform and a JAVA Platform, Enterprise Edition.

5. The computer implemented method of claim 1, further comprising:
passing child correlation tokens across applications on a same platform using an ILogicalThreadAffinative interface and a CallContext object.

6. The computer implemented method of claim 1, further comprising:
generating the request to be sent to a remote data processing system;
extracting a parent correlation token from the request;
creating a first child correlation token;
generating a first unique transaction handle associated with the child correlation token;
starting a timer associated with the first unique transaction handle and the first child correlation token;
inserting the first child correlation token and the first unique transaction handle into the request; and
sending the request to the remote data processing system.

7. The computer implemented method of claim 6, further comprising:
receiving the response;
extracting the extracted transaction handle from the response, wherein the extracted transaction handle is the first unique transaction handle; and
stopping the timer associated with the first unique transaction handle.

8. The computer implemented method of claim 7, further comprising:
providing a module, wherein the module manipulates a header of the request and a header of the response in order to extract or insert correlation tokens and unique transaction handles.

9. The computer implemented method of claim 8, wherein the module provides management functionality.

10. The computer implemented method of claim 8, wherein the module is loaded as a global SOAP Extension module.

11. The computer implemented method of claim 8, wherein the module is a JAVA™ Application Programming Interfaces (APIS) for eXtensible Markup Language (XML)-based Remote Procedure Call (JAX-RPC) or a JAVA API for XML-based Web Services (JAX-WS) handler module.

12. A computer program product comprising:
a computer storage medium having computer usable program code for managing a transaction between a service client and a service provider, the computer program product comprising:
computer usable program code for receiving a request from the Web services client application;
computer usable program code for extracting a correlation token and a unique transaction handle associated with the correlation token from the request, forming an extracted correlation token and an extracted transaction handle;
computer usable program code for generating a child correlation token using the extracted correlation token as a parent correlation token;
computer usable program code for generating a unique transaction handle associated with the child correlation token;
computer usable program code for starting a timer associated with the unique transaction handle and child correlation token;
computer usable program code for performing the request;
computer usable program code for stopping the timer associated with the unique transaction handle;
computer usable program code for inserting the extracted transaction handle in a response to the request; and
computer usable program code for transmitting the response with the extracted transaction handle to a Web services client application.

13. The computer program product of claim 12, further comprising:
computer usable program code for defining a message header format that allows for correlation tokens to be exchanged between the service client and the service provider, wherein the service client and the service provider reside on different platforms.

14. The computer program product of claim 12, further comprising:
computer usable program code for generating the request to be sent to a remote data processing system;
computer usable program code for extracting a parent correlation token from the request;
computer usable program code for creating a first child correlation token;
computer usable program code for generating a first unique transaction handle associated with the child correlation token;
computer usable program code for starting a timer associated with the first unique transaction handle and the first child correlation token;
computer usable program code for inserting the first child correlation token and the first unique transaction handle into the request; and
computer usable program code for sending the request to the remote data processing system.

15. The computer program product of claim 14, further comprising:
computer usable program code for receiving the response;
computer usable program code for extracting the extracted transaction handle from the response, wherein the extracted transaction handle is the first unique transaction handle; and
computer usable program code for stopping the timer associated with the first unique transaction handle.

16. The computer program product of claim 12, wherein the computer usable program code are stored in a computer readable storage medium in a data processing system, and wherein the computer usable program code was downloaded over a network from a remote data processing system.

17. The computer program product of claim 12, wherein the computer usable program code are stored in a computer readable storage medium in a server data processing system, and wherein the computer usable program code are downloaded over a network to a remote data processing system for use in a readable storage medium with the remote system.

18. A data processing system for managing a transaction between a service client and a service provider, the data processing system comprising:
a bus;
a communications unit connected to the bus;
a storage device connected to the bus, wherein the storage device includes computer usable program code; and
a processor unit connected to the bus, wherein the processor unit executes the computer usable program code to receive a request from the Web services client application;
extract a correlation token and a unique transaction handle associated with the correlation token from the request, forming an extracted correlation token and an extracted transaction handle; generate a child correlation token using the extracted correlation token as a parent correlation token; generate a unique transaction handle associated with the child correlation token; start a timer associated with the unique transaction handle and child correlation token; perform the request; stop the timer associated with the unique transaction handle; insert the extracted transaction handle in a response to the request; and transmit the response with the extracted transaction handle to the Web services client application.

19. The data processing system of claim 18, wherein the processor further executes the computer usable program code to define a message header format that allows for correlation tokens to be exchanged between the service client and the service provider, wherein the service client and the service provider reside on different platforms.

20. The data processing system of claim 18, wherein the processor further executes the computer usable program code to generate the request to be sent to a remote data processing system; extract a parent correlation token from the request; create a first child correlation token; generate a first unique transaction handle associated with the child correlation token; start a timer associated with the first unique transaction handle and the first child correlation token; insert the first child correlation token and the first unique transaction handle into the request; and send the request to the remote data processing system.

21. The data processing system of claim 20, wherein the processor further executes the computer usable program code to receive the response; extract the extracted transaction handle from the response, wherein the extracted transaction handle is the first unique transaction handle; and stop the timer associated with the first unique transaction handle.

22. A system for managing a transaction between a service client and a service provider, the system comprising:
a receiving mechanism for receiving a request from a Web services client application;
an extracting mechanism for extracting a correlation token and a unique transaction handle associated with the correlation token from the request, forming an extracted correlation token and an extracted transaction handle;
a first generating mechanism for generating a child correlation token using the extracted correlation token as a parent correlation token;
a second generating mechanism for generating a unique transaction handle associated with the child correlation token;
a staring mechanism for starting a timer associated with the unique transaction handle and child correlation token;
a performing mechanism for performing the request;
a stopping mechanism for stopping the timer associated with the unique transaction handle;
a inserting mechanism for inserting the extracted transaction handle in a response to the request; and
a transmitting mechanism for transmitting the response with the extracted transaction handle to a Web services client application.

23. The system of claim 22, further comprising:
a third generating mechanism for generating the request to be sent to a remote data processing system;
a second extracting mechanism for extracting a parent correlation token from the request;
a creating mechanism for creating a first child correlation token;
a fourth generating mechanism for generating a first unique transaction handle associated with the child correlation token;
a second starting mechanism for starting a timer associated with the first unique transaction handle and the first child correlation token;
a second inserting mechanism for inserting the first child correlation token and the first unique transaction handle into the request; and
a sending mechanism for sending the request to the remote data processing system.

24. The system of claim 23, further comprising:
a second receiving mechanism for receiving the response;
a third extracting mechanism for extracting the extracted transaction handle from the response, wherein the extracted transaction handle is the first unique transaction handle; and
a second stopping mechanism for stopping the timer associated with the first unique transaction handle.

25. A computer implemented method for managing a transaction between a service client and a service provider, the computer implemented method comprising:
receiving a request from a Web services client application;
extracting a correlation token and a unique transaction handle associated with the correlation token from the request, forming an extracted correlation token and an extracted transaction handle;
generating a child correlation token using the extracted correlation token as a parent correlation token;
generating a unique transaction handle associated with the child correlation token;
starting a timer associated with the unique transaction handle and child correlation token;
performing the request;
responsive to a determination that there are downstream transactions to be performed, generating, for each downstream transaction, a new child correlation token using the extracted correlation token as a parent correlation token and a new unique transaction handle associated with the new child correlation token;
responsive to generating a new child correlation token using the extracted correlation token as a parent correlation token and a new unique transaction handle associated with the new child correlation token, starting a timer for each downstream transaction, wherein each timer is associated with the new unique transaction handle and the associated new child correlation token;
responsive to starting a timer that is associated with the new unique transaction handle and the associated new child correlation token, performing each downstream transaction;
responsive to performing each downstream transaction, stopping the timer associated with the new unique transaction handle;
stopping the timer associated with the unique transaction handle;
inserting the extracted transaction handle in a response to the request; and
transmitting the response with the extracted transaction handle to a Web services client application.
